(19) United States
(12) Patent Application Publication
(10) Pub. No.: US 2026/0097390 A1
(43) Pub. Date: Apr. 9, 2026

(54) Regeneration apparatus for waste powder activated carbon

(71) Applicant: WINTEC GLOVIS Co., Ltd., Seoul (KR)

(72) Inventors: Cheol Ho SHIN, Namyangju-si (KR); Min Jun Kye, Gwangmyeong-si (KR); Jae Jun Lee, Seoul (KR); June Hyung Park, Seoul (KR); Seong Joo Park, Seoul (KR); Jae Sang Kwon, Uiwang-si (KR)

(21) Appl. No.: 18/977,457

(22) Filed: Dec. 11, 2024

(30) Foreign Application Priority Data
Oct. 8, 2024 (KR) 10-2024-0136858

(51) Int. Cl. B01J 20/34; B01D 46/00; B01J 20/20

(52) U.S. Cl. CPC B01J 20/3466; B01D 46/0006; B01J 20/20; B01J 20/3416

(57) ABSTRACT

Disclosed is a device of regenerating powdered activated carbon using superheated steam according to the present invention, the device being capable of enhancing the efficiency of regeneration of the activated carbon in a powder form by performing a regeneration process using the steam having a high temperature in order to eliminate a problem which is that the efficiency of the regeneration decreases extremely due to carbonization resulting from exposure to a high temperature at the time of the regeneration of the powdered activated carbon which is activated carbon in power structure.

### CROSS-REFERENCE TO RELATED APPLICATION

This patent application claims priority to Korean Patent Application No. 10-2024-0136858, filed on Oct. 8, 2024, in the Korean Intellectual Property Office, the entire contents of which are hereby incorporated by reference.

This patent application is to be filed as a result of the development of technology concerning a process of regenerating high efficiency activated carbon using superheated steam (research period: Jul. 1, 2024˜Dec. 31, 2027) with respect to the materials and components technology development project (task serial number: RS-2024-00455655) performed by the Korean Ministry of Trade, Industry and Energy.

### BACKGROUND OF THE INVENTION

### Field of the Invention

The present invention relates to a regeneration device of regenerating powdered activated carbon using superheated steam.

### Description of the Related Arts

In general, activated carbon is classified into powdered activated carbon, granular activated carbon, and so on according to physical shapes and is selectively used for the fields of electronic and steel industries, and recovering of solvents, the treatment of waste water, the treatment of air pollutants, and so on according to fields of the treatment of contaminants, the conditions of removal, and so on.

In case that waste activated carbon used for environment and production processes, and so on is disused as it is, this is able to be a main factor of secondary environmental pollution and an economic loss is also large. Accordingly, it is necessary to use the waste activated carbon through regeneration, and currently, the waste activated carbon has generally been regenerated by a decompression regeneration method, a heating attachment and detachment method, a chemical regeneration method, a solvent regeneration method, a displacement regeneration method, an oxidation dissolution regeneration method, and so on.

The regeneration method used the most in a place where activated carbon is used in large quantities includes a low temperature heating regeneration method and a high temperature heating regeneration method, the low temperature heating regeneration method has mainly been used for the use of a gas phase of solvent adsorption, and so on, and the high temperature heating regeneration method has mainly been used for the use of a liquid phase of flat water, waste water, and so on.

The high temperature heating regeneration method is carried out, with respect to carrying out heat treatment in a rotary kiln or a multistage kiln at a high temperature of 800° C. to 1000° C. similarly with a production process of activated carbon, through a drying step of drying waste activated carbon, a high temperature heating step in which remaining adsorbate is carbonized, and an activation step in which the carbonized adsorbate is removed by gasifying during work by an oxidative gas, such as steam, a carbonic acid gas, oxygen, and so on.

However, since an oxidizing agent is used at the high temperature, a loss of the activated carbon occurs, and in such a process, a micropore is magnified into a macropore while being destroyed. Accordingly, since the adsorption force of a substance whose molecular weight is small decreases, it is disadvantageous in that adsorption ability of the activated carbon reduces largely and hardness decreases. Also, in case that regeneration facilities for these methods are installed in the field, it is problematic in that a wide space is required, massive facilities expenses consume, and a decline in performance resulting from regeneration occurs.

In particular, in case that the powdered activated carbon is used, it is problematic in that it is difficult to perform treatment processing due to scattering, and in the case that the high temperature-based heat treatment is carried out in the multistage kiln or the rotary kiln at the high temperature, it is problematic in that since the powdered activated carbon is easily carbonized due to a physical property of the activated carbon in a particulate form, it is difficult to regenerate it, and although the powdered activated carbon goes through a regeneration process, its performance decreases remarkably.

### RELATED ART DOCUMENT

### Patent Document

Korean Patent Registration No. 0563549
Korean Patent Registration No. 0446695

### SUMMARY OF THE INVENTION

The present invention has been devised for solving the aforesaid problems, and an object of the present invention is to provide a regeneration device capable of enhancing efficiency of the regeneration of activated carbon in a powder form by performing a regeneration process using steam having a high temperature in order to eliminate a problem which is that the regeneration efficiency decreases extremely due to carbonization resulting from exposure to the high temperature at the time of the regeneration of the powdered activated carbon which is activated carbon having powder structure.

With respect to a means for solving the aforesaid problems, according to one exemplary embodiment of the present invention, as illustrated in FIG. 1 to FIG. 6, a device of regenerating powdered activated carbon may be provided, the device comprising: a regeneration module 100 configured to perform regeneration by receiving the powdered activated carbon flowing in and spraying superheated steam into a receiving space, and furnished with a regeneration housing A having airtight structure; and a steam discharge module 200 configured to carry out separation and discharge by causing the powdered activated carbon regenerated in the regeneration module 100 to be discharged through a discharge unit B which discharges the powdered activated carbon regenerated and causing mixed superheated steam containing the fine powdered activated carbon used in the regeneration process to pass through a filtering unit C, wherein the steam discharge module 200 further comprises a separation unit D disposed at one side of the regeneration housing A and configured to additionally separate the powdered activated carbon and the steam by causing the mixed superheated steam which has passed through the filtering unit C to move through scattering prevention plates mounted into the inside.

Also, with respect to the regeneration device of the powdered activated carbon, the filtering unit C of the steam discharge module 200 may comprise: a combination body part 210 combined, in an attachable and detachable form, with a safe receipt part C1 formed at one side of the regeneration module 100, and furnished with a plurality of divided space portions; and a filtering part 220 in which at least one or more of perforating members 212 and mesh members 214 disposed on the whole surface of the combination body part 210 are disposed to be adjacent to a granular activated carbon-embedded part 216.

Furthermore, with respect to the regeneration device of the powdered activated carbon, the combination body part 210 may be embodied into a shape like a case inserted into the safe receipt part C1 in the structure of an implantable type and may be configured in such a manner that the perforating member 212, the mesh member 214, and the granular activated carbon-embedded part 216 are disposed in order.

Furthermore, with respect to the regeneration device of the powdered activated carbon, the separation unit D of the steam discharge module 200 may comprise: a separation body part D1 configured to form a movement pathway from a lower portion to an upper portion by receiving the mixed superheated steam having a high temperature which has passed through the filtering unit C; a plurality of scattering prevention plates D2 disposed to be spaced apart from one another in the inside of the separation body part D1; and a washing unit mounted to an upper portion of the separation body part D1, thereby washing the scattering prevention plates D2 and the inside of the separation body part D1.

In this case, with respect to the regeneration device of the powdered activated carbon, the scattering prevention plates D2 may maintain regularly spaced distances between the lower portion and the upper portion of the separation body part D1 and may be disposed on an inner surface of the separation body part D1 alternately in directions opposite to each other.

Furthermore, the regeneration device of the powdered activated carbon may further comprise a movement channel unit E configured to move the mixed superheated steam which has passed through the separation unit D, wherein the movement channel unit E is furnished with a condensation water discharge part E2 configured to discharge condensation water by causing a bending part E1 bent in one area to be formed.

Also, the regeneration device of the powdered activated carbon may further comprise: a dust collection module 300 connected to an end of the movement channel unit E; and a combustion module 400 configured to cause the mixed superheated steam which has passed through the dust collection module 300 to be burnt.

Moreover, with respect to the regeneration device of the powdered activated carbon, the regeneration module 100 may be configured so that the receiving space is formed in the inside of the regeneration housing A, wherein a lower surface A1 of the regeneration housing A is embodied in inclined structure so that a pathway through which the powdered activated carbon flowing in from an inflow part for the powdered activated carbon moves is formed.

Moreover, the regeneration device of the powdered activated carbon may further comprise a superheated steam spray module F disposed at an inner side of the regeneration housing A, wherein the superheated steam spray module F comprises: a first spray nozzle unit F1 disposed in a direction on a level with an upper area of the regeneration housing A, thereby spraying the superheated steam in a downward direction; and a second spray nozzle unit F2 disposed in structure of being spaced apart from the lower surface A1 of the regeneration housing and disposed to be inclined along inclined structure.

Also, with respect to the regeneration device of the powdered activated carbon, the second spray nozzle unit F2 may comprise: a main inflow pipe M to which the superheated steam is supplied;

an upper spray nozzle part A in which a spray nozzle configured to spray the superheated steam through the main inflow pipe M1 is disposed in a direction of a receiving space portion; a lower spray nozzle part B embodied to be disposed in a direction of the lower surface A1 of the regeneration housing; and an end spray nozzle part C disposed at an end portion of the main inflow pipe M.

According to said one exemplary embodiment of the present invention, the regeneration device can enhance the regeneration efficiency of activated carbon in a powder form by performing a regeneration process using steam having a high temperature in order to eliminate a problem which is that the regeneration efficiency decreases extremely due to carbonization resulting from exposure to the high temperature at the time of the regeneration of the powdered activated carbon which is the activated carbon having powder structure.

In particular, the regeneration device of the powdered activated carbon according to said one exemplary embodiment of the present invention carries out collection after the regeneration of the powdered activated carbon in a particulate form and filters out, through a steam discharge part, the residue of the regenerated activated carbon contained in the superheated steam with a high temperature used in the regeneration so as to be furnished with a filtering module capable of increasing a yield rate of the regenerated activate carbon.

In case of the filtering module according to the present invention, it is advantageous in that since the filtering module is produced in the form of a filtering unit comprising a granular activated carbon layer, the powdered activated carbon is adsorbed to granular activated carbon which is a thicker particle than it so as to be reused, and it is also advantageous in that since the granular activated carbon layer itself of the filtering unit is exposed to the superheated steam with the high temperature, the granular activated carbon layer can be recycled continuously, can be used continuously without the trouble of replacement, and can be used into activated carbon by being collected later.

Furthermore, when the mixed superheated steam with the high temperature which is filtered out is discharged, since the activated carbon in a remaining powder form scatters, in order to prevent a risk of air pollution, an arrangement structure in which scattering prevention plates are repeated is formed so that the powdered activated carbon which remains lastly can be collected and can be collected by being mixed with water through washing, and thus the efficiency of collection can increase.

Also, it is advantageous in that since a discharge pipe line having structure, which shows that condensation water is discharged by the superheated steam having the high temperature and discharged being collected, is formed, and finally remaining dust is collected and is burnt, a risk of air pollution can be eliminated and environment-friendliness can improve.

### BRIEF DESCRIPTION OF THE DRAWINGS

FIG. 1 illustrates, as a block diagram, main constitution which constitutes a device of regenerating powdered activated carbon according to one exemplary embodiment of the present invention.

FIG. 2 illustrates a sectioned conceptual view concerning the regeneration device of the powdered activated carbon according to said one exemplary embodiment of the present invention aforesaid in FIG. 1.

FIG. 3 is a perspective conceptual view illustrating an embodied example of the regeneration device of the powdered activated carbon according to said one exemplary embodiment of the present invention aforesaid in FIG. 1 and FIG. 2.

FIG. 4 is a conceptual view illustrating an exemplary embodiment of a filtering module of the regeneration device of the powdered activated carbon according to said one exemplary embodiment of the present invention on the basis of FIG. 3.

FIG. 5 illustrates a front conceptual view on the basis of FIG. 3.

FIG. 6 illustrates an image when seen from a side of the conceptual view shown in FIG. 3.

FIG. 7 and FIG. 8 illustrate the formative structure of a combustion module according to the present invention described above.

### DETAILED DESCRIPTION OF THE INVENTION

The advantages and features of the present invention, and the methods for accomplishing them will be clear with reference to the accompanying drawings and the exemplary embodiments described below in detail. However, the present invention should not be limited to the exemplary embodiments described herein, but may be embodied in the other forms. Rather, the exemplary embodiments introduced herein are provided so that the contents disclosed herein can be thorough and complete and can fully convey the scope of the present invention to those skilled in the art.

The terms used in the present application are only intended for describing specific exemplary embodiments and are not intended to limit the present invention. The singular forms are intended to include the plural forms as well, unless the context clearly indicates otherwise. In the present application, the terms, such as “comprise” or “have” and so on, are intended to show that there are features, numerals, steps, operations, constituent elements, component parts, or a combination thereof described in the specification, and should not be construed as previously excluding a possibility of the existence or addition of one or more of other features, or numerals, steps, operations, constituent elements, component parts, or a combination thereof.

Unless the definitions are indicated otherwise, all the terms used herein including technical or scientific terms have the same meanings as those that are commonly understood to those having ordinary skill in the technical field to which the present invention pertains. Also, the terms as generally used and defined in a dictionary should be construed as having meanings corresponding to contextual meanings concerning the relevant technology and should not be interpreted ideally or excessively as having formal meanings, unless they are clearly defined in the present application.

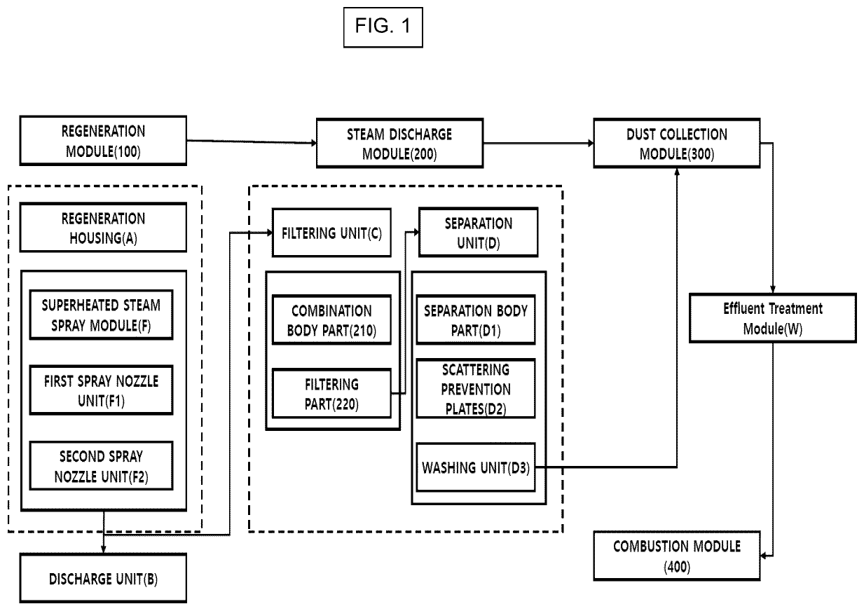

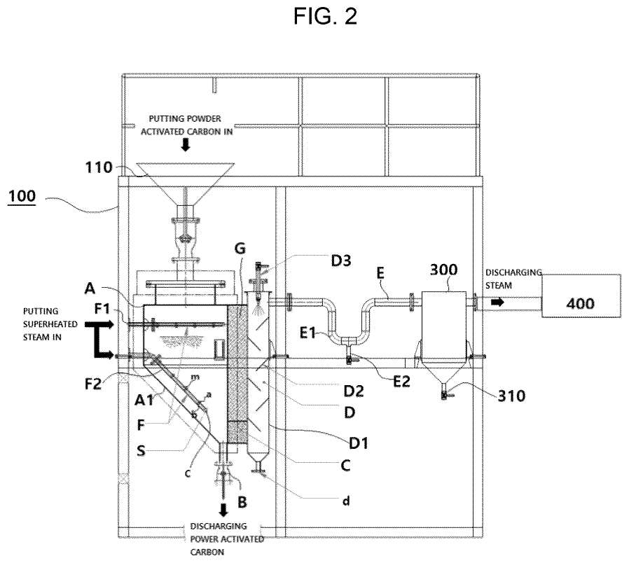

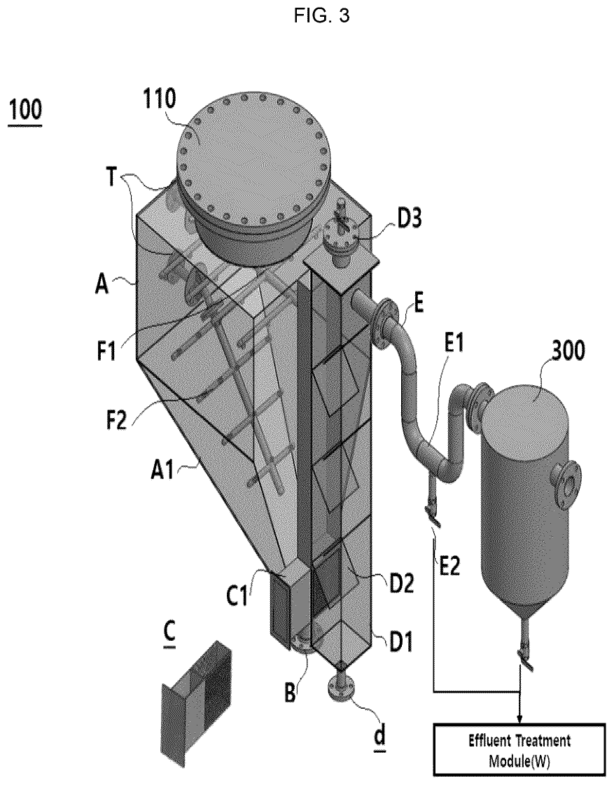

FIG. 1 illustrates, as a block diagram, main constitution which constitutes a device of regenerating powdered activated carbon (hereinafter referred to as “the present invention”) according to one exemplary embodiment of the present invention. FIG. 2 illustrates a sectioned conceptual view concerning the regeneration device of the powdered activated carbon according to said one exemplary embodiment of the present invention aforesaid in FIG. 1. FIG. 3 is a perspective conceptual view illustrating an embodied example of the regeneration device of the powdered activated carbon according to said one exemplary embodiment of the present invention aforesaid in FIG. 1 and FIG. 2.

Referring to FIG. 1 to FIG. 3, the device according to the present invention comprises: a regeneration module 100 furnished with a regeneration housing A having airtight structure and configured to receive powdered activated carbon flowing in and to cause superheated steam to be sprayed within a receiving space, thereby carrying out regeneration; and a steam discharge module 200 configured to carry out separation and discharge by causing the powdered activated carbon regenerated in the regeneration module 100 to be discharged through a discharge unit B which discharges the powdered activated carbon regenerated and causing mixed superheated steam containing the fine powdered activated carbon used in the regeneration process to pass through a filtering unit C.

The regeneration module 100 has the regeneration housing A in a tank type having the airtight structure and furnished with the receiving space in its inside and functions to regenerate the powdered activated carbon which is a target of regeneration by receiving the superheated steam supplied from a supply source intended for supplying the superheated steam having a high temperature within the regeneration housing A and by spraying the superheated steam into the inside.

In particular, in case that the regeneration housing A according to the present invention regenerates the powdered activated carbon coming in from an upper portion and loads it onto the bottom, the regeneration housing is embodied into a lower surface A1 having inclined structure so that the powdered activated carbon can naturally move into a discharge part B along an inclined surface.

For this, in an internal space of the regeneration module 100, a superheated steam spray module F disposed in an inner side of the regeneration housing A is further included, wherein the superheated steam spray module F comprises: a first spray nozzle unit F1 disposed in a direction on a level with an upper area of the regeneration housing A, thereby spraying the superheated steam into a downward direction; and a second spray nozzle unit F2 disposed to be separated from the lower surface A1 of the regeneration housing and disposed to be inclined along the inclined structure.

Specifically, referring to FIG. 2 and FIG. 3, after the powdered activated carbon which is a target of regeneration is put into the inside of the regeneration housing A through an input part 110, the superheated steam flows in through a superheated steam supply part T and is sprayed through the first spray nozzle unit F1 and the second spray nozzle unit F2 described above.

Since the powdered activated carbon generally has particle size distribution in the size range of 5 micrometer to 150 micrometer (no more than 100 mesh), it is characteristic in that the powdered activated carbon is piled up on the bottom by coming down while flowing into the inside of the regeneration housing A and scattering into the internal space.

Thus, the first spray nozzle unit F1 according to the present invention is disposed into the direction on a level with the upper area of the regeneration housing A so that the superheated steam is sprayed into a downward direction, and the spray nozzle is disposed in the downward direction so as to spray the superheated steam with a high temperature at high pressure, thereby causing the powdered activated carbon which scatters and is distributed into the inside to be regenerated.

This regeneration process of the powdered activated carbon is carried out by comprising a process of heating an organic matter ingredient adsorbed to waste activated carbon at the boiling point or more by supplying the superheated steam to the waste activated carbon, and of carrying out separation by raising the temperature, a process of thermally decomposing the volatile organic compound (VOC) ingredient in a gas phase which is separated, and a process of restoring a micropore within the waste activated carbon with pore distribution of the latest activated carbon.

It is preferable that the second spray nozzle unit F2 according to the present invention is disposed, as illustrated in FIG. 2 and FIG. 3, along inclination of the lower surface of the regeneration housing A according to the present invention having the structure of an inclined bottom surface.

In particular, in case that the regeneration housing A according to the present invention regenerates the powdered activated carbon flowing in from the upper portion and load it onto the bottom, the regeneration housing is embodied into the lower surface A1 having the inclined structure so that the powdered activated carbon can naturally move to the discharge part B along the inclined surface, and the second spray nozzle unit F2 is spaced apart from the lower surface A1 at a regular interval S, and is also arranged to be inclined along the inclined structure.

Also, it is more preferable that the second spray nozzle unit F2 is fully furnished with an upper nozzle part A which sprays the superheated steam sprayed through the spray nozzle toward an upper direction of the regeneration housing A, and a lower nozzle part B which sprays the superheated steam onto the lower surface A1 inclined.

The upper nozzle part A has a collision with the superheated steam sprayed from the first spray nozzle unit F1, functions to cause the powdered activated carbon in the inside to be stirred and mixed, and is able to enhance efficiency of the regeneration by providing lots of chances to further come into contact with the superheated steam.

Simultaneously with this, the lower nozzle part B realizes regeneration by spraying the superheated steam onto the powdered activated carbon, which is stacked or remains along the inclined surface, at strong pressure and is also able to function to cause the powdered activated carbon of the bottom to be lifted upward, thereby coming into contact with much more superheated steam.

Moreover, in the case of the lower nozzle part B, an end spray part C is disposed at an end portion of a main spray pipe M so that the powdered activated carbon which is regenerated and is piled up downward can easily flow into the discharge part B in such a manner as to spray the strongly superheated steam into an inclination direction.

Next, the present invention has the discharge part B which guides the powdered activated carbon regenerated in the regeneration housing A downward, thereby discharging it. The discharge part B may comprise a discharge line B1 and a discharge valve B2 formed in a downward direction from a point at which the inclination of the lower surface of the regeneration housing A comes to an end, and may cause the powdered activated carbon regenerated to be separated and collected.

The superheated steam with the high temperature used in the regeneration process through the regeneration housing A is discharged in a form of being mixed with a part of the powdered activated carbon (hereinafter referred to as “the mixed superheated steam), and according to the present invention, the filtering unit C, which is capable of causing the steam having the high temperature to be discharged by filtering out impurities from the steam at the same time as causing the powdered activated carbon regenerated and mixed with the mixed superheated steam to be collected by filtering out the mixed superheated steam, may further be included

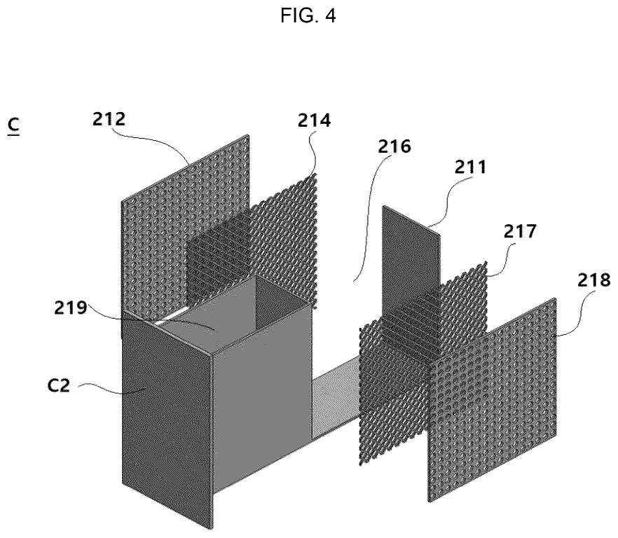

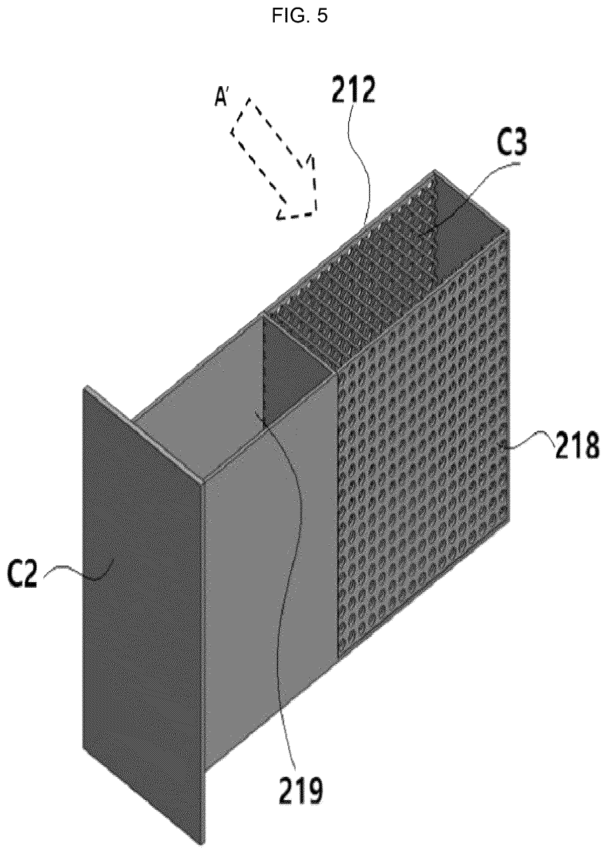

The filtering unit C may be disposed to be adjacent to the discharge part B formed at the end portion of the regeneration housing A according to the present invention, and the form thereof may be embodied into structure like a module which is attachable and detachable in a drawer type as shown in FIG. 3, FIG. 4, and FIG. 5.

Specifically, referring to FIG. 2 and FIG. 3, the filtering unit C may comprise: a combination body part 210 combined, in an attachable and detachable form, with a safe receipt part C1 formed at one side of the regeneration module 100 and furnished with a plurality of divided space portions; and a filtering part 220 in which at least one or more of perforating members 212 and mesh members 214 disposed on the whole surface of the combination body part are disposed to be adjacent to a granular activated carbon-embedded part 216.

That is, since the filtering unit C is inserted and mounted into the safe receipt part C1 in an insertion and combination form and is embodied in structure which is that when the filtering unit is replaced by a new one or is removed, the filtering unit is attachable and detachable in the drawer type so as to cause an internal filter constitution to be removed or replaced, its use and maintenance management can be performed conveniently.

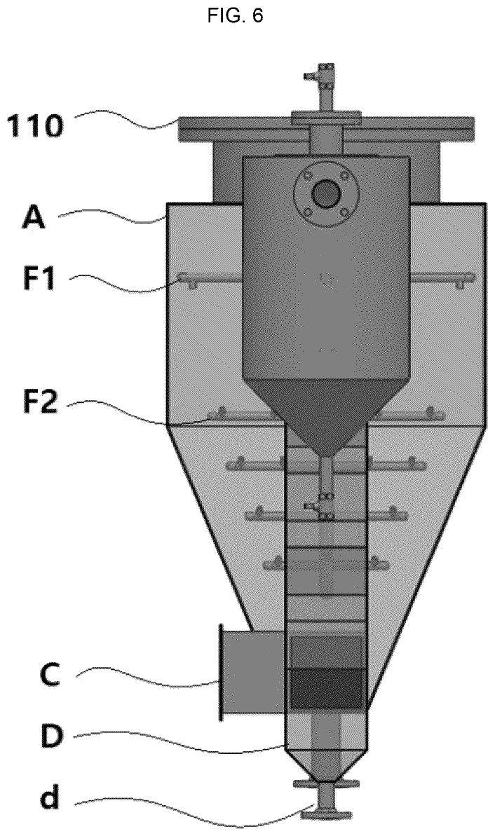

FIG. 4 is a disassembled conceptual view of the filtering unit according to the present invention, FIG. 5 is a combined conceptual view of the filtering unit shown in FIG. 4, and FIG. 6 illustrates an image when seen from a side of the conceptual view shown in FIG. 3.

Referring to FIG. 4 and FIG. 5, the filtering unit C is configured in such a manner that in an inflow direction A′ of the mixed superheated steam used in the regeneration as a standard, the perforating plate 212, in which a plurality of perforated holes configured to primarily receive the mixed superheated steam flowing in and to filter out it are formed, and the mesh member 214, which is formed in the structure of a mesh form, are disposed in order, thereby filtering out impurities, such as a carbide and so on, in addition to the superheated steam and the powdered activated carbon.

The mixed superheated steam filtered out repeatedly as described above flows into a granular activated carbon layer filled in the granular activated carbon-embedded part 216.

The mixed superheated steam passes through the granular activated carbon layer filled in the granular activated carbon-embedded part 216, the powdered activated carbon contained in the mixed superheated steam is adsorbed to the granular activated carbon layer and goes through a process of being separated from the superheated steam, and a filtering process is naturally realized.

Later, only the granular activated carbon layer can be used by being separated and being then processed into regenerated activated carbon, and only the powdered activated carbon can separately be collected by being separated using a method, such as high-pressure air spray and so on.

When the granular activated carbon layer used into this filter layer generates a problem which is that an internal gap disappears according to use, although a process of being filled with a new granular activated carbon layer later should be performed later, according to the present invention, thanks to a regeneration action by a high temperature which the mixed superheated steam has, the use and regeneration are repeated, so the number of use and the period of use increase remarkably.

That is, the mixed superheated steam with a high temperature according to the present invention, which passes through the granular activated carbon layer, nearly maintains the temperature used in the regeneration process intactly, and the temperature generally reads 400° C. or so. Accordingly, an action of causing the regeneration process to be performed from the granular activated carbon layer itself is realized.

Furthermore, in the filtering unit C according to the present invention, a perforating plate 217 or a mesh member 218 may additionally be disposed at the back of the granular activated carbon-embedded part 216 as needed, and an auxiliary filtering part 219 may additionally be formed as needed. In this case, since the auxiliary filtering part 219 is additionally furnished with the granular activated carbon-embedded part 216 having the granular activated carbon layer described above so that the mixed superheated steam can stay in a space of the auxiliary filtering part, the auxiliary filtering part may be embodied so that the efficiency of filtering of the mixed superheated steam described above can enhance.

Also, a cover part C2 configured to cause a user to embody an attachable and detachable process to manual is provided on the whole surface portion of the filtering unit C so that operation can easily be realized.

With respect to the mixed superheated steam with the high temperature which has passed through the filtering unit C, as illustrated in FIG. 2 and FIG. 3, a separation unit D, which is disposed to be adjacent to a side portion of the regeneration housing A, and which has broad width in a heightwise direction, is disposed.

The separation unit D causes the mixed superheated steam which has passed through the filtering unit C disposed at the lower portion of the regeneration housing A to move from the bottom to the top, and in the movement process, the separation unit functions to collect the powdered activated carbon again which minutely remains in the inside of the mixed superheated steam.

To do so, the separation unit D according to the present invention is disposed at one side of the regeneration housing A so as to additionally separate the powdered activated carbon and the steam by causing the mixed superheated steam which has passed the filtering unit C to move through the scattering prevent plates mounted into the inside.

The mixed superheated steam flowing into the separation unit D is steam in a state of its temperature being reduced from about 400° C. to about 100° C. before the mixed superheated steam passes through the filtering unit C, and the powdered activated carbon which is mixed partially and minutely corresponds to regenerated activated carbon for which the regeneration process is mostly completed.

Thus, in the separation unit D according to the present invention, under the condition that a pipe conduit disposed at a side of the regeneration housing A and having broad width in a lengthwise direction is embodied in airtight structure, the scattering prevention plates are disposed in the inside to cross each other in zigzag structure so that the mixed superheated steam can collide therewith and the remaining powdered activated carbon can be adsorbed to the scattering prevention plates.

For this, the separation unit D may cause a movement pathway which reaches an upper portion from a lower portion to be formed by receiving the mixed superheated steam with the high temperature which has passed through the filtering unit C, and the separation unit may comprise: a separation body part D1 disposed to be adjacent to a side portion of the regeneration housing A and embodied into structure like a closed pipe conduit having a long channel in a heightwise direction; a plurality of scattering prevention plates D2 disposed in the inside of the separation body part D1 to be spaced apart from one another; and a washing unit D3 mounted to an upper portion of the separation body part D1, thereby washing the scattering prevention plates and the inside of the separation body part D2.

In this case, it is characteristic in that the scattering prevention plates D2 maintain regularly spaced distances between a lower portion and an upper portion of the separation body part D1 and are disposed on an inner surface of the separation body part D1 alternately in directions opposite to each other.

That is, as illustrated in FIG. 2, since a pathway into which the mixed superheated steam flows and through which the mixed superheated steam moves is formed from the lower portion to the upper portion, the scattering prevention plates D2 function to prevent a part of the regenerated powdered activated carbon mixed within the mixed superheated steam from scattering by the greatest collision and to cause the regenerated powdered activated carbon to remain by being adsorbed onto or colliding with one surface of the scattering prevention plates.

To do so, the plurality of scattering prevention plates are disposed in structure of being disposed alternately to cross each other from positions opposite to each other in an inward direction of the separation body part D1 and are embodied into inclined structure (structure having an inclination angle which makes an acute angle in a downward direction) rather than horizontal structure, and the scattering prevention plates cause mixing, and the staying time of thermal steam to increase, so the function to prevent the powdered activated carbon from scattering and to cause the residue of the powdered activated carbon to be adsorbed can be carried out efficiently.

In particular, in the upper portion of the separation body part D1, as illustrated in FIG. 2 and FIG. 3, the washing unit D3 is disposed so that the powdered activated carbon adsorbed onto the scattering prevention plates can be collected to the lower portion through the spray nozzle N configured to spray washing water in the inside of the lower portion and can be discharged through an outlet D.

Like the process described above, the mixed superheated steam, which passes through the filtering unit C and the separation body part D, and which causes the powdered activated carbon to be filtered out and collected, keeps only activated carbon in a dust form and in a very slight quantity and contains some ingredients of condensation water.

Thus, the mixed superheated steam which has passed through the separation body part D moves through a movement channel unit E, and in this case, a bending area E1 as illustrated in FIG. 2 and FIG. 3 is formed in one area of a transfer pipe conduit, and the steam stays in the bending area E1 and causes the condensation water condensed to be discharged through a condensation water discharge part E2.

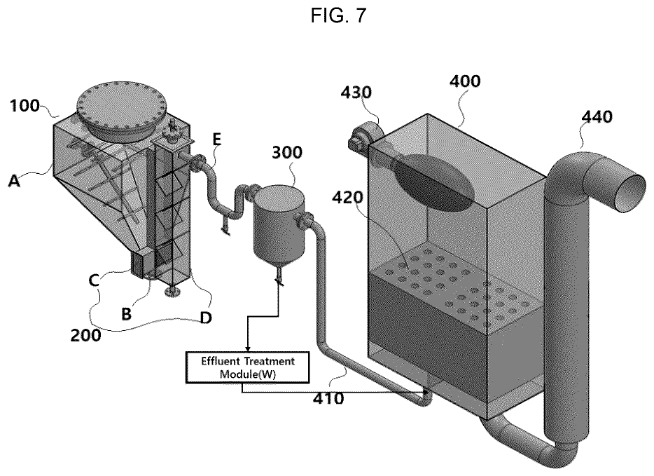

Also, the steam which causes the condensation water to be discharged flows into the dust collection module 300, thereby causing minute dust to be adsorbed, and then the mixed superheated steam flows into the combustion module 400 (shown in FIG. 7), thereby finally being burnt and discharged.

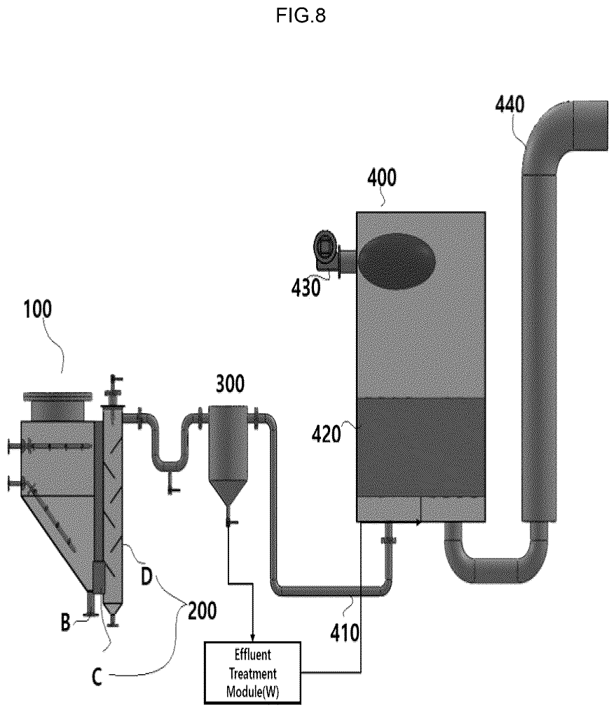

FIG. 7 and FIG. 8 illustrate formative structure of the combustion module 400 according to the present invention described above.

Referring to FIG. 7 and FIG. 8, the steam which causes the condensation water to be discharged flows into the dust collection module 300, thereby causing the minute dust to be adsorbed. Like this, after the minute dust is removed through the dust collection module 300, the mixed superheated steam flows into the combustion module 400 through a transfer pipe 410.

The mixed superheated steam which flows into the inside of the combustion module 400 goes through a preheating process in a heat exchanger 420, and then the preheated air is heated at a high temperature of about 750° C. to about 1,000° C. in a combustion chamber through a combustion burner 430, so noxious gas, such as volatile organic compounds (VOCs) and so on, is burnt.

That is, since the noxious gas generated in the regeneration process is also contained within the superheated steam having the high temperature, a contaminant like VOCs is burnt at the high temperature so as to be removed by converting into carbon dioxide and water.

In this case, heat generated in the combustion process through the heat exchanger is collected, and the heat is reused in a process so that the efficiency of energy can enhance, operation expenses can reduce, and environment-friendliness can be secured by the discharged steam being discharged in a purified state.

As previously described, although the present invention has been described based on the preferable exemplary embodiments, it will be apparent to those having ordinary skill in the technical field to which the present invention pertains that the technical idea of the present invention should not be construed as being limited thereto and that modifications or alternations can be made within the scope of the claims described, and it is to be understood that these modifications or alternations falls with the scope of the accompanying claims.

What is claimed is:

1. A device of regenerating powdered activated carbon, the device comprising:
an activated carbon regeneration module configured to perform regeneration by receiving the powdered activated carbon flowing in and spraying superheated steam into a receiving space, and furnished with a regeneration housing having airtight structure; and
and a steam discharge module configured to carry out separation and discharge by causing the powdered activated carbon regenerated in the activated carbon regeneration module to be discharged through a discharge unit which discharges the powdered activated carbon regenerated and causing mixed superheated steam containing the fine powdered activated carbon used in the regeneration process to pass through a filtering unit,
wherein the steam discharge module further comprises a separation unit disposed at one side of the regeneration housing and configured to additionally separate the powdered activated carbon and the steam by causing the mixed superheated steam which has passed through the filtering unit to move through scattering prevention plates mounted into the inside.

2. The device of claim 1, wherein the filtering unit of the steam discharge module comprises:
a combination body part combined, in an attachable and detachable form, with a safe receipt part formed at one side of the regeneration module and furnished with a plurality of divided space portions; and
a filtering part in which at least one or more of perforating members and mesh members disposed on the whole surface of the combination body part are disposed to be adjacent to a granular activated carbon-embedded part.

3. The device of claim 2, wherein the combination body part is embodied into a shape like a case inserted into the safe receipt part in the structure of an implantable type and is configured in such a manner that the perforating member, the mesh member, and the granular activated carbon-embedded part are disposed in order.

4. The device of claim 3, wherein the separation unit of the steam discharge module comprises:
a separation body part configured to form a movement pathway from a lower portion to an upper portion by receiving the mixed superheated steam having the high temperature which has passed through the filtering unit;
a plurality of scattering prevention plates disposed to be spaced apart from one another in the inside of the separation body part; and
a washing unit mounted to an upper portion of the separation body part, thereby washing the scattering prevention plates and the inside of the separation body part.

5. The device of claim 4, wherein the scattering prevention plates maintain regularly spaced distances between the lower portion and the upper portion of the separation body part and are disposed on an inner surface of the separation body part alternately in directions opposite to each other.

6. The device of claim 5, wherein the regeneration device of the powdered activated carbon further comprises a movement channel unit configured to move the mixed superheated steam which has passed through the separation unit,
wherein the movement channel unit is furnished with a condensation water discharge part configured to discharge condensation water by causing a bending part bent in one area to be formed.

7. The device of claim 6, wherein the regeneration device of the powdered activated carbon further comprises:
a dust collection module connected to an end of the movement path unit; and
a combustion module configured to cause the mixed superheated steam which has passed through the dust collection module to be burnt.

8. The device of claim 7, wherein the regeneration module is configured so that the receiving space is formed in the inside of the regeneration housing,
wherein a lower surface of the regeneration housing is embodied in inclined structure so that a pathway through which the powdered activated carbon flowing in from an inflow part for the powdered activated carbon inflow part moves is formed.

9. The device of claim 8, wherein the regeneration device of the powdered activated carbon further comprises a superheated steam spray module disposed at an inner side of the regeneration housing,
wherein the superheated steam spray module comprises: a first spray nozzle unit disposed in a direction on a level with an upper area of the regeneration housing, thereby spraying the superheated steam in a downward direction; and a second spray nozzle unit disposed in structure of being spaced apart from the lower surface of the regeneration housing and disposed to be inclined along inclined structure.

10. The device of claim 9, wherein the second spray nozzle unit comprises:
a main inflow pipe to which the superheated steam is supplied;
an upper spray nozzle part in which a spray nozzle configured to spray the superheated steam through the main inflow pipe is disposed in a direction of a receiving space portion;
a lower spray nozzle part embodied to be disposed in a direction of the lower surface of the regeneration housing; and
an end spray nozzle part disposed at an end portion of the main inflow pipe.
